(19) United States
(12) Patent Application Publication
(10) Pub. No.: US 2025/0318629 A1
(43) Pub. Date: Oct. 16, 2025

(54) SYSTEMS AND METHODS FOR LOCATION-BASED ACTIVATION AND/OR APPLICATION OF MAKEUP LOOKS

(71) Applicant: ELC MANAGEMENT LLC, Melville, NY (US)

(72) Inventor: Christopher Aidan, Austin, TX (US)

(21) Appl. No.: 18/637,076

(22) Filed: Apr. 16, 2024

(51) Int. Cl. A45D 44/00; G06T 11/60

(52) U.S. Cl. CPC A45D 44/005; G06T 11/60; G06T 2200/24

(57) ABSTRACT

Techniques are disclosed for automatically activating, applying, and/or otherwise achieving a location-specific makeup look to a person. Based on detecting that the person has physically entering into a bounded location, a location-specific makeup look may be automatically triggered to be activated and applied to (or otherwise achieved on) the person by controlling one or more smart cosmetics apparatus(es). A location may be bounded by geospatial coordinates, date, day, time of day, occasion or event, and/or other desired parameters. The activated location-specific makeup look may be automatically customized and/or manually modified for the person based on the person's facial features, skin type, personal preferences, environmental characteristics of the physical location, an occasion and/or event corresponding to the bounded location, and/or characteristics of the cosmetic products that are applied to the person to achieve the location-specific makeup look.

### CROSS-REFERENCE TO RELATED APPLICATIONS

The present patent application relates to U.S. application Ser. No. 18/591,508 entitled “Smart Auto-Adjusting Handheld Makeup Applicator Device” and filed on Feb. 29, 2024; U.S. application Ser. No. 18/444,343 entitled “Smart Makeup Compact” and filed on Feb. 16, 2024; U.S. application Ser. No. 18/444,382 entitled “Smart Mirror with Makeup Look Superimposition and Guided Tracing” and filed on Feb. 16, 2024; and U.S. application Ser. No. 18/624,361 entitled “Cosmetic Application Assistance System Using Heads-Up Display (CAAS-HUD)” and filed on Apr. 2, 2024, the disclosures of which are hereby incorporated by reference herein in their entireties.

### TECHNICAL FIELD

The present disclosure relates generally to systems and methods for the automatic activation and/or application of makeup looks to a person based on the person's physical location.

### BACKGROUND

Presently, people may manually apply different makeup looks to themselves for different occasions, events, environments, and/or locations. Current makeup application techniques often require a significant amount of time and skill, making it difficult for people to switch between makeup looks quickly or quickly and easily adapt their makeup looks to different occasions, events, environments, and/or locations. Further, current makeup application techniques are not able to automatically apply a location-based makeup look to a person based on the person entering into a physical location. Still further, current makeup application techniques do not offer automatic customization and adaptation of location-based makeup looks based on a person's personal preferences and/or current characteristics of the physical location when the person enters into the physical location.

### SUMMARY

Techniques, systems, apparatuses, components, devices, and methods are disclosed for activating and/or applying (e.g., automatically activating and/or applying) makeup looks to a person based on the person's physical location, e.g., based on the person entering into a predefined physical location. A location-specific makeup look may be automatically triggered to be activated and applied to (or otherwise achieved on) the person upon detecting that the person has physically entered into an associated location. For example, when a person enters into a geo-fenced area, a geo-fenced location-specific makeup look may be automatically triggered to activate and be applied to the person. A location may be bounded by one or more parameters, such as geospatial coordinates (e.g., as utilized in geo-fencing), date, day, time of day, occasion or event, and/or other desired parameters. Additionally, the activated location-specific makeup look may be customized for a person based on the person's facial features, skin type, and/or personal preferences, as well as based on environmental characteristics of the bounded location, an occasion and/or event corresponding to the physical location, and/or characteristics of the cosmetic products that are applied to the person to achieve the location-specific makeup look, for example.

In an embodiment, a system includes a communication interface via which the system is communicatively connected to a smart cosmetics apparatus that is configured to cause makeup looks to be applied to a person. The system also includes a data store storing indications of associations between one or more bounded locations and a respective makeup look that is to be applied to the person when the person is within each bounded location of the one or more bounded locations. Additionally, the system includes one or more processors and computer-executable instructions that are stored on one or more memories of the system. When executed by the one or more processors, the computer-executable instructions cause the system to: detect, via one or more sensors, that the person has entered into a bounded location in which makeup looks of the person are to be controlled and, responsive to the detection, obtain, from the data store, an indication of a location-specific makeup look for the person while the person is within the bounded location and transmit, via the communication interface and a wireless transceiver, one or more control signals instructing the smart cosmetics apparatus to cause the location-specific makeup look to be applied to the person.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

FIG. 1 depicts an example system for location-based makeup look activation and/or application.

FIG. 2 depicts a flow diagram of an example method for automatically activating and/or applying makeup looks based on entry into a bounded or defined location.

While the systems and methods disclosed herein are susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

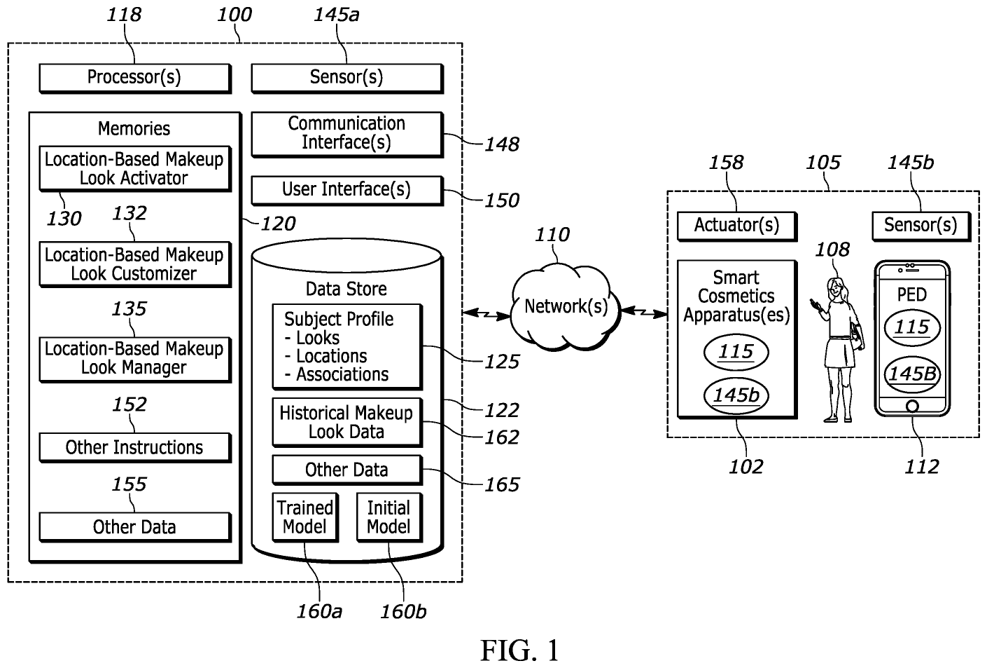

FIG. 1 depicts an example system 100 for location-based activation and/or application of makeup looks, e.g., automated location-based activation and/or application of makeup looks, according to embodiments. As utilized herein, the term “makeup look” generally and categorically refers to desired appearances or effects achieved by respective cosmetics products being applied to a person's face and/or body. Example makeup looks may include natural, glam, evening, matte, dewy, smokey, bridal, makeup looks that are specific to different acting roles, makeup looks that are specific to different clothing or combinations of clothing worn by the person, makeup looks that are specific to different hair colors of the person, etc. As utilized herein, the term “activation” of a makeup look generally refers to a determination or selection of a particular one of a plurality of candidate makeup looks, and the term “application” of a makeup look generally refers to physically applying one or more cosmetic products to a person's face and/or body and/or physically modifying the person's currently applied makeup to achieve the appearance or effect of the makeup look.

The system 100 for location-based activation and/or application of makeup looks may include or may be communicatively connected to a smart cosmetics apparatus 102 disposed in a physical location or area 105 in which makeup looks may be triggered to be activated or applied to a person 108 (who is interchangeably referred to herein as a “subject person 108”). The location or area 105 may be a geo-fenced area, or other type of area that is defined by corresponding geospatial coordinates or parameters. In some situations, the location or area 105 is further defined by other parameters, such as date, day, time of day, occasion or event, and/or other desired parameters. However, for ease of reading herein, and not for limitation purposes, both locations or areas that are defined by only geospatial coordinates/parameters, and locations or areas that are bounded by other parameters in addition to geospatial coordinates/parameters are generally, categorically, and interchangeably referred to herein as “areas,” “locations,” “bounded areas,” and/or “bounded locations.” The boundaries of bounded areas (whether based on geospatial coordinates and/or based on other bounding parameters) may be predefined, for example. Generally speaking, the system 100 may detect that a subject person 108 has entered into a bounded location 105. Upon the detection of the entry of the person 108 into the bounded location 105, the system 100 may determine and activate a location-specific makeup look which is to be applied to or otherwise achieved on the person 108 while the person 108 is located within the bounded area 105. The system 100 may generate one or more corresponding instructions or control signals and cause the instructions/control signals to be transmitted to the smart cosmetics apparatus 102 located within or at the bounded area 105. The smart cosmetics apparatus 102 may obtain the instructions/control signals and responsively operate to cause the location-specific makeup look to be applied to or otherwise achieved on the person 108.

In some embodiments (not depicted in FIG. 1), the smart cosmetics apparatus 102 is included in the system 100. In the example shown in FIG. 1, though, the system 100 and the smart cosmetics apparatus 102 are communicatively connected or coupled via one or more networks 110. The one or more networks 110 may be a single communication link directly connecting the system 100 and the smart cosmetics apparatus 102 (e.g., a direct wireless link), or one or more networks 110 may include multiple links and/or communication networks of one or more types (e.g., one or more wired and/or wireless local area networks (LANs), and/or one or more wired and/or wireless wide area networks (WANs) such as the Internet, public networks, private networks, etc.). For case of reading herein (and not for limitation purposes), the one or more networks 110 may be referred to using the singular tense.

Generally, the smart cosmetics apparatus 102 may be an apparatus or device that includes one or more processors and one or more memories, and that is configured (e.g., via software and hardware) to at least partially control the application of cosmetic products, makeup, and/or makeup looks on a subject person, e.g., of the person 108. As such, the smart cosmetics apparatus 102 may include, for example, one or more robotic arms or other spatially maneuverable components; one or more sensors; one or more vessels, containers, or receptacles in which cosmetic products are housed or stored and from which the cosmetics products can be obtained for application onto the person 108; one or more valves or other type of dispensing components; one or more brushes, wands, pads, sponges, spray nozzles, and/or other types of cosmetic applicators; one or more actuators; one or more mirrors; one or more projectors; one or more cameras or image capturing devices; at least one display screen; and/or other components which may be utilized to control the application of makeup and/or of makeup looks on subject people. In some cases, the smart cosmetics apparatus 102 may include one or more virtual reality (VR) and/or augmented reality (AR) devices or components, if desired, via which desired makeup applications can be virtually previewed, modified, selected, etc., prior to being physically achieved on the person 108. For example, the smart cosmetics apparatus 102 may include one or more of the embodiments of the systems, apparatuses, devices, and/or components described in U.S. application Ser. No. 18/591,508 entitled “Smart Auto-Adjusting Handheld Makeup Applicator Device” and filed on Feb. 29, 2024; U.S. application Ser. No. 18/444,343 entitled “Smart Makeup Compact” and filed on Feb. 16, 2024; U.S. application Ser. No. 18/444,382 entitled “Smart Mirror with Makeup Look Superimposition and Guided Tracing” and filed on Feb. 16, 2024; and U.S. application Ser. No. 18/624,361 entitled “Cosmetic Application Assistance System Using Heads-Up Display (CAAS-HUD)” and filed on Apr. 2, 2024. The smart cosmetics apparatus 102 may include only a single integral, physical apparatus (such as depicted in FIG. 1) or may include a plurality of physical apparatuses (not explicitly shown in FIG. 1), which may or may not be communicatively interconnected. For ease of reading, though, and not for limitation purposes, the smart cosmetics apparatus 102 may be referred to herein using the singular tense.

The smart cosmetics apparatus 102 may include one or more wireless and/or wired communication interfaces via which the apparatus 102 may receive control signals and/or instructions from the system 100 and/or from a personal electronic device (PED) 112, and to which the apparatus 102 may be operably responsive. The wireless and/or wired communication interfaces may respectively include one or more wireless transceivers and/or one or more wired transceivers, for example. The control signals or instructions generated by and transmitted from the system 100 and/or the PED 112 and received at the smart cosmetics apparatus 102 via the wireless and/or wired communication interfaces may at least partially control the smart cosmetics apparatus 102 to cause at least a portion of an entire makeup look to be applied to or otherwise achieved on a subject person, such as the person 108. The generated instructions may be included (e.g., as payload) in one or more control signals which may be transmitted to the smart cosmetics apparatus 102 via a direct wired or wireless communication link communicatively connecting the smart cosmetics apparatus 102 to the system 100 and/or to the PED 112, or the one or more control signals may be delivered to the smart cosmetics apparatus 102 via multiple communication links (e.g., via the network 110) communicatively connecting the smart cosmetics apparatus 102 to the system 100 and/or to the PED 112. In some implementations, the smart cosmetics apparatus 102 may include or may be operably responsive to control signals and/or instructions transmitted by a corresponding application 115 executing on the PED 112 or other device disposed at the bounded location 105. For example, the system 100 may transmit instructions to the application 115, and the application 115 may transmit corresponding control signals to the smart cosmetics apparatus 102. Additionally or alternatively, in some arrangements, the smart cosmetics apparatus 102 may receive instructions transmitted from the system 100 and also may receive, from the application 115, modifications to received system instructions, such as modifications that are generated by the application 115 based on user input provided at a user interface of the PED 112.

As such, in some embodiments, the smart cosmetics apparatus 102 may include or may operate in conjunction with the application 115 to cooperatively cause makeup and/or makeup looks to be applied to the person 108. In an example, the application 115 may execute on the PED 112 that is physically disposed at the location 105, where the PED 112 may be operated by the subject person 108 to which makeup is to be applied or by another party, such as an agent of the person 108. In another example, the application 115 may execute on the smart cosmetics apparatus 102 itself. At any rate, whether via the application 115 executing on the PED 112 and/or via the application 115 executing on the smart cosmetics apparatus 102, the person 108 or agent of the person 108 may, via a corresponding user interface, preview the location-specific makeup look as applied to the person 108 (e.g., in virtual or augmented reality), modify aspects of the previewed location-specific makeup look, control and/or modify aspects of the application of the makeup look onto the person 108 (e.g., start, pause, slow down, speed up, change product and/or makeup application technique of product, etc.), etc., thereby providing a layer of localized, manual control of the smart cosmetics apparatus 102 in addition to the automatic control provided by the system 100, if desired.

In some embodiments, the smart cosmetics apparatus 102 may include and/or operate in conjunction with an actuator 158, which may be, for example, an actuating device or an actuating application. For example, the system 100 may transmit a control signal to an actuator 158, and the actuator 158 may activate or cause the smart cosmetics apparatus 102 to responsively operate to thereby cause the location-specific makeup look to be applied to the person 108. In some implementations, the actuator 158 may be integral with the smart cosmetics apparatus 102 (not shown in FIG. 1). For example, the actuator 158 may be a physical component of the smart cosmetics apparatus 102 and/or the actuator 158 may be an application or other type of computer-executable instructions executing on the smart cosmetics apparatus 102. In some implementations, the actuator 158 may be a separate device or application which is operably connected (e.g., in a wired and/or wireless manner) to the smart cosmetics apparatus 102. For example, the actuator 158 may be included in the application 115 executing on PED 112, or the actuator 158 may be a stand-alone actuating device 158 located in the vicinity of and operably coupled to the smart cosmetics apparatus 102, such as depicted in FIG. 1.

In some embodiments, the smart cosmetics apparatus 102 may include a smart cosmetics package in which a cosmetic product is housed or contained, and from which the housed or contained cosmetic product is dispensable. The smart cosmetics package may receive a control signal corresponding to an instruction generated by the system 100, and may responsively dispense an amount (e.g., a predetermined or instructed amount) of cosmetic product for applying to the person 108. In some embodiments, the smart cosmetics apparatus 102 may be or include a smart cosmetics applicator that is configured to operably apply makeup onto a person 108. The smart cosmetics applicator may receive a control signal corresponding to an instruction generated by the system 100, and may responsively cause one or more cosmetics products to be applied to the person 108 via one or more physical applicators included in the smart cosmetics applicator, e.g., brushes, wands, spray applicators, sponges, etc. One of a plurality of examples of smart cosmetics applicators, each of which may be responsive to control signals generated by the system 100, may be found in U.S. application Ser. No. 18/591,508 entitled “Smart Auto-Adjusting Handheld Makeup Applicator Device” and filed on Feb. 29, 2024.

In some embodiments, the smart cosmetics apparatus 102 may be or include a smart cosmetic product, which may or may not have been already applied to a person such as the subject person 108. The smart cosmetic product may receive a control signal corresponding to an instruction generated by the system 100, and may responsively modify its visual appearance (e.g., color, texture, gradient across an area, shape, etc.). The smart cosmetic product may operate in response to the instruction or control signal generated by the system 100 while the smart cosmetic product is contained in its container prior to being applied to the person 108, and/or while the smart cosmetic product is being worn by the person 108 after having been applied to person prior to the reception of the instruction/control signal. For example, the smart cosmetic product may responsively change its color, texture, and/or other aspects of its visual and/or tactile appearance.

In some embodiments, the smart cosmetics apparatus 102 may be or include a smart cosmetics guide that receives a control signal corresponding to an instruction generated by the system 100. Responsive to the received control signal, the smart cosmetics guide may generate and project or otherwise position an overlay on the person 108 (e.g., an augmented reality overlay), such as on the person's face or other desired part of the person's body, where the overlay is indicative of a guide to and/or a template for applying at least a portion of a location-specific makeup look to the person 108. The overlay may be specifically customized for the person 108 and/or for the bounded location 105, such as in manners described in more detail elsewhere herein. A few of a plurality of examples of smart cosmetics guides, each of which may be responsive to control signals generated by the system 100, may be found in U.S. application Ser. No. 18/444,343 entitled “Smart Makeup Compact” and filed on Feb. 16, 2024; U.S. application Ser. No. 18/444,382 entitled “Smart Mirror with Makeup Look Superimposition and Guided Tracing” and filed on Feb. 16, 2024; and U.S. application Ser. No. 18/624,361 entitled “Cosmetic Application Assistance System Using Heads-Up Display (CAAS-HUD)” and filed on Apr. 2, 2024.

Further, as previously discussed, in some embodiments, the smart cosmetics apparatus 102 may include multiple apparatuses. For example, the smart cosmetics apparatus 102 may include a smart cosmetics guide, a smart cosmetics applicator, and smart cosmetics packaging. The system 100 may generate respective instructions for each of the smart cosmetics guide, the smart cosmetics applicator, and the smart cosmetics packing with respect to applying a location-specific makeup look to the person 108. In response to receiving respective instructions, the smart cosmetics guide may generate and position the overlay on the subject person 108, the smart cosmetics packaging may dispense a desired amount of cosmetics product, and the smart cosmetics applicator may automatically operate to apply the dispensed amount of cosmetic product to the person 108 in accordance with the positioned overlay.

Turning now to the system 100, the system 100 may include one or more remote and/or local servers, a group (e.g., cluster or cloud) of multiple servers, and/or one or more other suitable types of computing devices or systems. As previously discussed, in some embodiments, the system 100 includes or is communicatively connected with a personal electronic device (PED) 112 of the subject person 108 (or of an agent of the subject person 108) disposed at the bounded location 105. In these embodiments, the PED 112 may be a smart phone, a smart device, a wearable device, a laptop, a tablet, or another type of PED that is being carried, ported, worn, or otherwise utilized by the subject person 108 (or by an agent of the subject person 108). The PED 112 may be paired with, authenticated to, and/or authorized to communicate with the system 100 prior to communicating with the system 100, if desired. Further, in some embodiments, the system 100 may include or be in communicative connection with a remote application 115 that is stored and executing on the PED 112 and/or on the smart cosmetics apparatus 102. For example, the remote application 115 may be a client of the server(s) of the system 100, the remote application 115 may be a local interface to a web service hosted by the servers(s) of the system 100, etc. The remote application 115 may be authenticated and/or authorized to communicate with the system 100 prior to communicating with the system 100, if desired. Generally, the system 100 and the remote application 115 may cooperatively operate to cause location-specific makeup looks to be activated and applied to the subject person 108, such as in manners described elsewhere herein.

At any rate, whether the system 100 includes the PED 112, the smart cosmetics apparatus, the application 115, one or more servers, and/or one or more computing devices and/or systems, the system 100 generally includes one or more processors 118, which may or may not be distributed among a plurality of computing servers, devices, and/or systems of which the system 100 comprises. The one or more processors 118 may include any suitable number of processors and/or processor types (e.g., one or more central processing units (CPUs)); however, the one or more processors 118 may be referred to herein using the singular tense for case of reading (and not limitation) purposes. Generally, processor 118 is configured to execute (and the system 100 includes) software and/or other types of computer-executable instructions that are stored in one or more persistent memories 120 of system 100 and that particularly configure the system 100 to automatically, based on a subject person 108 entering into a predefined location or area 105, activate a location-specific makeup look for the person 108 and/or cause the location-specific makeup look for the person 108 to be applied to the person 108, e.g., via smart cosmetics apparatus 102.

As such, the system 100 may include a data store 122 in which a profile 125 of the subject person 108 may be stored. The profile 125 may store, for example, indications of one or more makeup looks which may be activated for the person 108, indications of one or more bounded locations at which location-specific makeup looks are to be applied to or otherwise achieved on the person 108, and a set of associations between various bounded physical locations or areas and corresponding location-specific makeup looks that are to be activated and/or applied to the person 108 at the various locations. The person 108 (or an agent of the person 108) may define, update, delete, and/or otherwise modify (e.g., via a user interface 150 of the system 100 and/or a user interface of the PED 112) information in the person's profile 125, such as different bounded locations, various location-specific makeup looks, and associations between bounded areas and location-specific make up looks, e.g., via location-based makeup look manager 135. Data store 122 may be implemented using one or more data storage devices and/or systems, such as local and/or remote data storage devices, data banks, distributed data storage systems, data clouds, etc. In some embodiments of the system 100, at least a portion of data store 122 may be included in the system 100 (e.g., in the one or more memories 120 or otherwise), and/or at least a portion of the data store 122 may be communicatively connected to the system 100 (e.g., via network 110). Of course, even though FIG. 1 depicts only a single profile 125 of the person 108 in which location-based makeup look information and associations are stored, it is understood that the data store 122 may store respective profiles of multiple people in which respective location-based makeup look information and associations are stored.

As further shown in FIG. 1, the system 100 includes the one or more persistent memories 120. The one or more persistent memories 120 may be tangible, non-transitory memories and may include Random Access Memories (RAMs), Read-Only Memories (ROMs), flash memory, hard drives, solid state memories, data banks, cloud data storage, and/or other types of persistent memories. In some implementations, the persistent memories 120 may include one or more persistent memories that are located remotely from the system 100 (e.g., remote data banks, etc.). Further, the one or more persistent memories 120 may or may not be distributed among a plurality of computer services, data storage devices, and/or systems of which the system 100 comprises. For example, the persistent memories 120 may include the data store 122 and/or one or more memories included in the PED 112. For ease of reading herein and not for limitation purposes the one or more memories 120 of the system 100 may be referred to herein using the singular tense.

The system 100 may include one or more sets of computer-executable instructions 130-140 that are stored on the memory 120 and executable by processor 118. As depicted in FIG. 1, the system 100 includes a location-based makeup look activator 130, a location-based makeup look customizer 132, and a location-based makeup look manager 135. Generally, and as is described in more detail elsewhere herein, the location-based makeup look activator 130 detects, via one or more local and/or remote sensors 145, that a subject person 108 has entered into a bounded location 105 in which a location-based make-up look is to be applied to the person 108, activates a location-specific makeup look associated with the bounded location and the person 108, and causes the location-specific makeup look to be achieved, via the smart cosmetics apparatus 102, on the person 108. The one or more sensors 145 may include one or more physical sensors (e.g., movement; heat; chemical; optical, wireless, and/or other types of radio frequency (RF); geospatial; sensors included in user interfaces, such as user interfaces of the PED 112 and/or the smart cosmetics apparatus 102; etc.) and/or may include one or more virtual or software sensors (e.g., image processing, biometric and/or other types of feature recognition of individuals, other types of software sensors which work in conjunction with data provided by hardware sensors, etc.). At least some of the sensors 145a may be included in the system 100, and/or at least some of the sensors 145b may be communicatively connected to the system 100. For example, one or more sensors 145a may be disposed locally at the system 100, and/or one or more sensors 145b may be disposed proximate to or at the bounded location 105 e.g., may be disposed remotely with respect to the system 100. For instance, at least one sensor 145b may be included in the PED 112 and/or in the application 115 executing at the PED 112; at least one sensor 145b may be included in the smart cosmetics apparatus 102 and/or in the application 115 executing at the smart cosmetics apparatus 102; and/or at least one sensor 145b may be included in or attached to some other type of mobile device disposed within or proximate to the bounded location 105 (not shown in FIG. 1). In some configurations, at least one sensor 145b may be fixedly disposed proximate to or at the bounded location 105. For example, such fixedly disposed sensors 145b may include a standalone sensor, an environmental sensor or camera, a sensor disposed at, attached to, or included in a router, adaptor, transceiver, or other fixedly disposed communication or networking component, etc.), and the like. At any rate, upon detecting that the subject person 108 has entered into the bounded location 105 based on data generated by the one or more sensors 145, the location-based makeup activator 130 may access the subject person's profile 125 stored in the data store 122 to determine and activate a particular makeup look for the person 108 while the person 108 is at the bounded location 105. Still, the location-based makeup activator 130 may generate one or more instructions or control signals to direct the smart cosmetics apparatus 102 to cause the activated makeup look to be applied to or otherwise achieved on the person 108 within the bounded location 105, and may cause the generated instructions/control signals to be transmitted to the smart cosmetics apparatus 102.

Accordingly, the system 100 may include one or more communication interfaces 148 via which the instructions and/or control signals may be transmitted from the system 100. The one or more communication interfaces 148 may include, for example, one or more wireless interfaces configured to support one or more wireless communications and/or data protocols (e.g., via respective wireless transceivers) and/or one or more wired interfaces configured to support one or more wired communications and/or data protocols (e.g., via respective wired transceivers). For example, system 100 may communicatively connect to the network 110 and/or directly to the smart cosmetics apparatus 102 via the one or more communication interfaces 148. The one or more communication interfaces 148 may include one or more wireless interfaces that are configured to transmit and receive data using a Bluetooth protocol, a Wi-Fi (IEEE 802.11 standard) protocol, a near-field communication (NFC) protocol, a cellular (e.g., GSM, CDMA, LTE, WiMAX, etc.) protocol, a peer-to-peer wireless protocol, a short-range wireless protocol, and/or other suitable wireless communication protocols. For case of reading (and not limitation) purposes, the one or more communication interfaces 148 may be referred to herein using the singular tense.

In some embodiments, the system 100 may include one or more user interfaces 150, at least one of which may be locally included in the system 100 and/or at least one of which may be remotely included in the PED 112, the smart cosmetics apparatus 102, or some other remote computing device. The one or more user interfaces 150 may include one or more suitable types of user input devices, such as keyboards, touch screen displays, microphones, and/or any suitable types of remote and/or local user input devices. Additionally, the one or more user interfaces 150 may include one or suitable types of output devices, such as touch screen displays, speakers, mice, touch pads, and the like. For ease of reading (and not limitation) purposes, the one or more user interfaces 150 may be referred to herein using the singular tense. Via the user interface 150, the person 108 may, for example, access the location-based makeup look manager 135 to define and/or modify different makeup looks, identify different bounded locations, define associations between different makeup looks and corresponding bounded locations, and/or otherwise administrate the set of various makeup looks, bounded locations, and respective associations as desired. Data and/or information corresponding to the administration and/or management of location-based makeup looks may be stored in the data store 122, for example.

In some implementations, the location-based makeup look customizer 132 of the system 100 may execute to customize a make-up look specifically for the person 108. For example, the data store 122 may store indications of facial features, skin types, and/or other physical characteristics of the person 108, where such indications of the individual physical characteristics of the person 108 may have been obtained a priori by using any suitable methods, e.g., automatic sensing, image analysis, data input, etc., and/or where such indications of the individual characteristics may be obtained in real-time (e.g., via the sensors 145) by using any suitable methods, e.g., automatic sensing, image analysis, data input, etc. Via the user interface 150 and the location-based makeup look manager 135, the person 108 may cause a desired makeup look to be provided to the system 100. For example, the person 108 may provide (e.g., upload) an image of a desired makeup look to the system 100. The location-based makeup look customizer 132 may operate on the provided image of the desired makeup look to customize the makeup look for the person 108 based on at least the indications of the facial features, skin types, and/or other characteristics of the person 108 stored in the data store 122. The customized makeup look may be stored in the data store 122 as a candidate makeup look for the person 108 which may be activated at some future time, and the person 108 may, via the user interface 150 and the location-based make-up look manager 135, define one or more associations of the customized, candidate makeup look with one or more bounded locations. Such associations may be stored in the person's profile 125, for example.

Of course, in some embodiments, the system 100 may include other instructions 152 and/or other data 155 stored on the memory 120. For example, the other instructions 152 may be executable by processor 118 to perform various functions to support and/or related to the location-based activation and/or application of makeup looks, and the other data 155 may include data that is read, stored, and/or otherwise utilized by the location-based makeup look activator 130, the location-based makeup look customizer 132, and/or the location-based makeup look manager 135, as well as other types of data. In some embodiments, the system 100 may include additional and/or alternate components not shown in FIG. 1.

Further, it is understood that when the system 100 is implemented as a distributed system, various components of the system 100 may be implemented in a distributed manner. For example, when the system 100 includes one or more servers, one or more smart cosmetics apparatuses, and/or one or more PEDs, at least some of each of the components 118, 120, 130-135, and 152-155 may be included in the one or more servers and at least some of each of the components 118, 120, 130-135, and 152-155 may be included in the one or more smart cosmetics apparatuses and/or the one or more PEDs. For example, a portion of the location-based makeup look activator 130 may execute at the system 100 and another portion of the location-based makeup look activator 130 may execute at the smart cosmetics apparatus 102 and/or at the PED 112. Additionally or alternatively, respective portions of the location-based makeup look customizer 132 and/or of the location-based makeup look manager 135 may execute at the system 100 and other respective portions of the location-based makeup look customizer 132 and/or of the location-based makeup look manager 135 may execute at the smart cosmetics apparatus 102 and/or at the PED 112. Such distributed configurations may be implemented using any suitable techniques such as, for example, client/server, web service/service call, etc.

With particular regard to embodiments of the system 100 in which the smart cosmetics apparatus 102 includes a smart cosmetics guide (e.g., such as previously described), in some implementations, the overlay generated by the smart cosmetics guide may be customized for the person 108, e.g., via the location-based makeup look customizer 132 and based on particular facial features, skin types, and other physical characteristics of the person 108. For example, an initial overlay may be modified based on stored indications of facial features, skin types, and/or other physical characteristics of the person 108, where the indications of the physical characteristics of the person 108 may be stored in the data store 122 of system 100. At least some of such stored indications of the individual physical characteristics of the person 108 may have been obtained a priori by using any suitable methods, e.g., automatic sensing, image analysis, data input, etc. and/or at least some of such indications of the individual characteristics may be obtained in real-time (e.g., via the sensors 145) by using any suitable methods, e.g., automatic sensing, image analysis, data input, etc. In some scenarios, at least some of the facial features, skin types, and/or other physical characteristics of the person 108 may be detected in real-time and/or in-line or in conjunction with the generation of the overlay. For example, the smart cosmetics guide may be communicatively connected to one or more sensors 145b disposed at the location 105 and, upon the smart cosmetics guide receiving the control signal from the system 100, the smart cosmetics guide may utilize real-time data obtained by the one or more sensors 145b at the location 105 to determine or detect at least some of the facial features, skin types, and/or other physical characteristics of the person 108, and may, e.g., by utilizing the location-based makeup look customizer 132, modify an initial overlay accordingly to thereby customize the initial overlay specifically for the person 108 in view of the determined/detected facial features, skin types, and/or other physical characteristics of the person 108. In some embodiments, one or more preferences of the person 108 may be stored in the data store 122, and the initial overlay may be additionally or alternatively customized for the person 108 in accordance with the stored preferences. If desired, the customized overlay for the person 108 may be stored in the data store 122. In an embodiment, the location-based makeup look customizer 132 may execute to customize overlays and/or makeup looks specifically for the person 108, e.g., in real-time or on demand.

In some implementations, the overlay generated by the smart cosmetics guide may be additionally or alternatively customized for the location 105. For example, an initial overlay may be additionally or alternatively customized (e.g., by utilizing the location-based makeup look customizer 132) for the person 108 at the bounded location 105 based on other characteristics such as location- or environment-based physical characteristics at the bounded location 105 (e.g., e.g., humidity, lighting, wind, temperature, etc.), an occasion or event corresponding to the bounded location 105 and for which the location-specific makeup look is to be applied to the person 108, respective properties of one or more cosmetics products that are to be applied to the person 108 to achieve the location-specific makeup look, and the like. At least some of such other characteristics affecting the customization of the overlay (such as the environmental characteristics, event or occasion, cosmetic product properties, etc.) may have been determined a priori and stored in the data store 122, and/or at some of such other characteristics affecting the customization of the overlay may be determined in real-time and/or in conjunction with the overlay. For example, the smart cosmetics guide may be communicatively connected to one or more sensors 145b disposed at the location 105 and, upon the smart cosmetics guide receiving the control signal from the system 100, the smart cosmetics guide may utilize real-time data obtained by the one or more sensors 145b to determine at least some of the current characteristics which may inform the customization of the overlay for the person 108 (e.g., one or more current characteristics of the environment in which the person 108 is located, one or more respective properties of various cosmetics products within the environment, etc.), and may modify (e.g., by utilizing the location-based makeup look customizer 132) an initial overlay accordingly, thereby customizing the initial overlay for the person 108 at the location 105. If desired, the customized overlay for the person 108 at the location 105 may be stored in the data store 122, e.g., in the person's profile 125.

In some embodiments, a customization of the overlay for the person 108 may be performed at least in part by a trained machine learning (ML) model 160a that is stored at and executes at the system 100 (e.g., as depicted in FIG. 1) and/or at the smart cosmetics apparatus 102 (not shown in FIG. 1). For example, an initial ML model 160b may be trained (e.g., by executing training instructions included in the other instructions 152) based on historical data 162 that includes data indicative of historical applications of a plurality of makeup looks on the person 108 and/or data indicative of historical applications of respective makeup looks that have been applied to a plurality of other people. Such historical data 162 (which is also referred to interchangeably herein as “training data 162”) may include, for example, data or information indicative of a respective one or more facial features of the person 108 and/or of the plurality of other people, a skin type of the person 108 and/or of the plurality of other people, one or more other physical characteristics of the person 108 and/or the plurality of other people, one or more personal preferences of the person 108 and/or the plurality of other people, respective characteristics of a plurality of different environments in which the historical makeup looks were applied, one or more properties of respective pluralities of cosmetic products used in creating the historical makeup looks, makeup application techniques that were utilized in the applications of the historical makeup looks, and identities of the plurality of historical makeup looks, as well as other characteristics and/or properties that are associated with historical application of makeup looks. A “makeup application technique,” as utilized interchangeably herein, generally refers to how, where, and/or in what pattern and/or order various cosmetics products are applied to a person, for example, the combination of different cosmetics products that are applied, the formulation types of the different cosmetic products (e.g., powder, liquid, gel, etc.), tools that are utilized, the order and/or the layering in which the different cosmetic products are applied, the particular regions of the face and/or body to which the different cosmetics products are applied, combinations thereof, etc. The initial ML model 160b, the historical data 162, and the trained ML model 160a may be stored at the system 100, e.g., in the data store 122, the one or more memories 120, and/or other suitable data storage locations.

At any rate, the initial ML model 160b may be trained on the historical data 162 to determine, for a particular set of environmental characteristics of a location, a particular set of cosmetic product properties, and a subject person's facial features, skin type, and/or other individual physical characteristics (and optionally a subject person's personal preferences), one or more makeup application techniques that are to be utilized and/or one or more cosmetic products that are to be applied to various regions or areas on the subject person to achieve a particular makeup look on the subject person at the location. Such a trained ML model 160a may be stored at the data store 122 of the system 100, and may be utilized by the system 100 to generate an overlay or guide to applying various cosmetics products that is customized for both the person 108 and the location 105 to achieve the particular makeup look on the subject person 108 at the location 105. For example, indications of the person's physical characteristics, the person's personal preferences, location- or environment-based physical characteristics, and/or cosmetic product properties may be obtained (e.g., as stored a priori and/or by real-time sensing, such as in manners previously discussed), and may be input into the trained ML model 160a along with an indication of a desired makeup look that is to be applied to or otherwise achieved on the person 108 at the location 105. Based on the inputs, the trained ML model 160a may output a customized overlay or guide for the person 108 where the customized overlay or guide is indicative of various makeup application techniques and/or cosmetic products that are to be applied to various regions of the face and/or body of the person 108 to achieve the desired makeup look on the person 108 at the location 105. As such, in embodiments, the trained ML model 160a may be included in and/or utilized by the location-based makeup look customizer 132 of the system 100.

In some scenarios, upon its generation, the custom overlay may be physically applied to or projected onto the person 108, and the smart apparatus 102 may operate to physically apply cosmetics products and/or to modify one or more properties of one or more cosmetics products that have been previously applied to the person 108 in accordance with the custom overlay to thereby achieve the desired makeup look. In some scenarios, upon its generation and prior to the physical application to and/or modification of cosmetics products on the person 108, an initial custom overlay may be virtually applied to an image of the person 108 and virtual cosmetic products may be applied to the image of the person 108 in accordance with the initial custom overlay, e.g., in a real-time augmented reality (AR) or virtual reality (VR) image, so that the person 108 and/or the person's agent may preview the location-based makeup look on the person 108. For example, the virtual preview of the location-based makeup look applied to the person 108 may be displayed on a user interface 150 of the system 100 and/or on a user interface of a PED 112 disposed at the location 105. Based on the displayed preview, the person 108 and/or the person's agent may modify (e.g., via one or more user interfaces 150 the system 100 and/or via one or more user interfaces of the PED 112) the virtual appearance of the location-based makeup look on the person 108, and the initial custom overlay may be updated to reflect the modifications. An approved, updated custom overlay may be stored in the person's profile 125 at the data store 120 for current and/or future use, and may be added to the historical data 162 stored in the system 100 to thereby generate updated historical data 162. Subsequently, the trained ML-model 160a may be re-trained using the updated historical data 162, and the re-trained ML model may be saved at the system 100 and utilized to generate a second custom overlay for the person 108. The second custom overlay may correspond to the location 105 or to another location, to the desired makeup look or to another desired makeup look, etc.

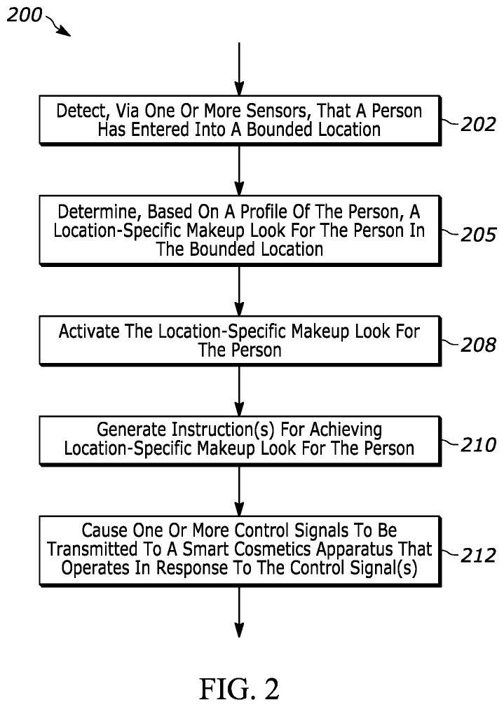

FIG. 2 depicts a flow diagram of an example method 200 for automatically activating and/or applying makeup looks based on a subject person's entry into a bounded or defined location, according to embodiments. For example, an instance of the method 200 may be executed when a person whose makeup looks are to be controlled based on location enters into a geo-fenced or otherwise bounded location (e.g., a location which is bounded or defined by geospatial coordinates, date, day, time of day, occasion or event, and/or other desired parameters). In an embodiment, at least a portion of the method 200 is performed by a system for location-based activation and/or application of makeup looks, such as the system 100. For example, the location-based makeup look activator 130, the location-based makeup look customizer 132, and/or the location-based makeup look manager 135 stored on the memories 120 of the system 100 may be executed by processors 118 to cause the system 100 to execute at least a portion of the method 200. For ease of discussion herein (and not for limitation purposes), the method 200 is described with simultaneous reference to FIG. 1 including the system 100 and the smart cosmetics apparatus 102, although it is understood that any one or more portions of the method 200 may be utilized in systems other than the example system 100 and/or in conjunction with one or more smart cosmetics apparatuses other than apparatus 102. Further, in some embodiments the method 200 may include additional or alternate blocks other than those depicted in FIG. 2.

At a block 202, the method 200 may include detecting, via one or more sensors, that a subject person has entered into a bounded area in which makeup looks of the subject person are to be controlled. For example, the location-based makeup look activator 130 and/or the instructions 152 executing at the system 100 may detect 202 that the person 108 has entered into the bounded location 105 based on data generated by one or more sensors 145. Detecting 202 that the subject person 108 has entered into the bounded area 105 may, in some embodiments, include determining the identity of (e.g., identifying) the subject person 108 at least partially based on the data generated by the one or more sensors 145. For example, determining the identity of the subject person 108 may include utilizing facial or other biometric recognition, obtaining an identity of the person 108 based on information transmitted by a PED 112 operated and/or worn by the person 108, obtaining user input at a user interface of the smart cosmetics apparatus 102 and/or the PED 112, and/or by utilizing other suitable identification techniques. In some situations, detecting 202 that the subject person 108 has entered into the bounded area 105 may include authenticating the determined identity of the person 108. Identification and/or authentication verification information of the person 108 with which sensed data can be compared and verified may be stored in the data store 122 of the system 100, e.g., in a subject profile 125 of the person 108 and/or elsewhere within the data store 122.

At a block 205, the method 200 may include determining, based on a profile of the subject person, a location-specific makeup look that is to be applied to or otherwise achieved on the person while the person is located within the bounded location. For example, the location-based makeup look activator 130 executing at the system 100 may access the subject profile 125 of the person 108 to determine whether makeup looks for the person 108 are to be controlled for the bounded location 105, e.g., based on the set of associations between bounded locations and makeup looks stored in the person's profile 125, and, if so, which specific location-specific makeup look is to be applied to or achieved on the person 108 at the bounded location 105. In some scenarios, determining 205 a particular location-specific makeup look may be based on user input. For example, if the subject person's profile 125 indicates that multiple makeup looks have been associated with the bounded location 105, the determining 205 of a particular location-specific makeup look from among the multiple makeup looks may include obtaining an indication of a user selection of the particular location-specific makeup look. The user input may be received via a user interface of the PED 112 and/or via a user interface of the smart cosmetics apparatus 102, for example. In some scenarios, determining 205 a particular location-specific makeup look for the person 108 may be based on sensed data and/or parameters. For example, if the subject person's profile 125 indicates that multiple makeup looks have been associated with the bounded location 105, the determining 205 of the location-specific makeup look may include selecting, by the location-based makeup look activator 130 and without obtaining any additional user input, a particular location-specific makeup look from the multiple associated makeup looks based on sensed data and/or parameters, such as current humidity within the bounded location 105, current lighting conditions within the bounded location 105, a time of day or date, an event, a current availability of particular cosmetics products within the bounded location 105, the type(s) of smart cosmetics apparatus(es) present at the bounded location 105, etc.

At a block 208, the method 200 may include activating the determined or selected location-specific makeup look for the subject person 108. In embodiments, activating 208 the location-specific makeup look may include obtaining an identifier of the determined or selected location-specific makeup look and/or storing an association (e.g., via an indication in the profile 125 or elsewhere in the data store 122) of the determined location-specific makeup look and the person 108, optionally with a corresponding timestamp and/or other related data, e.g., to thereby record a specific instance of the location-specific makeup look being activated 208 for the person 108. In embodiments, activating 208 the location-specific makeup look may additionally or alternatively include obtaining an indication of one or more makeup application techniques and/or cosmetics products which are to be utilized in achieving the determined location-specific makeup look. For example, each location-specific makeup look indicated in the subject person's profile 125 may be achieved by a respective combination of makeup application techniques and/or cosmetics products, and obtaining the indication of the one or more makeup application techniques and/or cosmetics products which are to be utilized to achieve the determined location-specific makeup look for the person 108 may include obtaining an identifier of a respective combination of makeup application techniques and/or cosmetics products for the determined location-specific makeup look. Additionally or alternatively, obtaining the indication of the one or more makeup application techniques and/or cosmetics products which are to be utilized in achieving the determined location-specific makeup look for the person 108 may include and/or obtaining a list, guide, inventory, instructions, or details of at least a portion of the respective combination of makeup application techniques and/or cosmetics products associated with determined location-specific makeup look for the person 108.

At any rate, such indications, identifiers, and/or details of the respective combinations of makeup application techniques and/or cosmetics products for the location-specific makeup looks may be stored in the data store 122, e.g., in association with the profile 125 of the subject person 108 and/or as other data 165. Additionally or alternatively, such indications, identifiers, and/or details of the respective combinations of makeup application techniques and/or cosmetic products for the location-specific makeup looks may be stored at the smart cosmetics apparatus 102 and/or at the PED 112. For implementations in which information indicative of at least portions of the indications, identifiers, and/or details of the respective combinations of makeup application techniques and/or cosmetics products for the location-specific makeup looks are stored both at the system 100 and at the smart cosmetics apparatus 102 and/or the PED 112, the contents of the information may be synchronized between the system 100 and the smart cosmetics apparatus 102 and/or the PED 112, e.g., periodically, on demand, and/or as the information changes.

At a block 210, the method 200 may include generating one or more instructions for applying or otherwise achieving the activated location-specific make up look on the subject person, and at a block 212, the method 200 may include causing one or more control signals corresponding to the one or more instructions to be transmitted to a smart cosmetics apparatus that responsively operates to cause the location-specific make up look to be applied to or otherwise achieved on the subject person. For example, the location-based makeup look activator 130 may generate the one or more instructions and cause one or more control signals corresponding to the one or more instructions to be transmitted to the smart cosmetics apparatus 102, e.g., via the communication interfaces 148 and the network 110, and/or via one or more wireless links disposed in the bounded area 105. For instance, at least some of the one or more instructions may be included as payload of the one or more control signals.

In some embodiments, generating 210 the one or more instructions for applying or otherwise achieving the activated location-specific makeup look on the subject person 108 may include simply providing an identifier of the combination of makeup application techniques and/or cosmetics products used to achieve the activated location-specific look in the instructions and optionally an indication of the identity of the subject person 108. In these embodiments, the smart cosmetic apparatus 102 may store the details of the various combinations of makeup application techniques and/or cosmetics products for multiple different makeup looks, and may utilize the provided identifier to obtain the respective details corresponding to the activated location-based makeup look for the person 108. In some embodiments, generating 210 the one or more instructions for applying or otherwise achieving the activated location-specific makeup look on the subject person 108 may include providing at least some of the details (and/or indications thereof) of the makeup application techniques and/or cosmetics products that are to be utilized to achieve the activated location-based makeup look on the person 108 in the instructions.

Additionally or alternatively, in some embodiments, generating 210 the instructions and causing 212 the control signals to be transmitted may include, in some embodiments, determining which types of smart cosmetics apparatuses 102 are located and/or available at the bounded location 105, and generating respective instructions and causing respective control signals to be transmitted in accordance with the determined types. For example, if both smart cosmetics packaging and a smart cosmetics applicator are located within the bounded location 105, the block 210 may include generating a first set of instructions for the smart cosmetics packaging to operate in achieving the activated location-based makeup look on the person 108 and generating a second set of instructions for the smart cosmetics applicator to operate in achieving the determined location-based makeup look on the person 108, and the block 232 may include causing respective control signals to be transmitted to the smart cosmetics packaging and to the smart cosmetics applicator.

Still additionally or alternatively, in some embodiments, generating 210 the one or more instructions for applying or otherwise achieving the activated location-specific make up look on the subject person 108 may include detecting or otherwise determining (e.g., via sensors 145) a current makeup look which is already being worn (e.g., which has already been applied) to the person 108, and determining, based on the combination of makeup application techniques and/or cosmetics products that are to be utilized to achieve the location-based makeup look, one or more instructions for modifying the currently-applied makeup look on the person 108 to achieve the activated location-specific makeup look. The instructions for modifying the currently-applied makeup look of the person 108 may be indicated and/or included in the control signals that are transmitted to the smart cosmetics apparatus(es) 102.

In some embodiments (not shown in FIG. 2), the method 200 may include, subsequent to the block 212, detecting that the person has exited from the bounded location. For example, the location-based makeup look activator 130 may detect that the person 108 has exited from the bounded location 105 based on data generated by the sensors 145 and optionally based on data generated by other sensors that are located outside of the bounded area 105, e.g., in a manner similar to that described with the respect block 202. In these embodiments, upon detecting that the person 108 has exited the bounded area 105, the method 200 may include deactivating the location-based makeup look (e.g., by recording as such in the subject person's profile 125 or otherwise in the data store 122) and optionally transmitting a second set of control signals instructing the smart cosmetic apparatus 102 and/or one or more other smart cosmetics apparatus(es) which are disposed outside of the bounded location 105 to cause the activated location-based makeup look that has been applied to the person to be modified or removed, e.g., in manners similar to those discussed for the blocks 210 and 212.

In some embodiments (not shown in FIG. 2), the method 200 may include generating and presenting a preview or simulation of the activated location-based makeup look for the subject person 108, and obtaining one or more modifications and/or an approval of the previewed/simulated location-based makeup look on the person 108. For example, subsequent to the block 208, the location-based makeup look customizer 132 may execute to present the preview or simulation of the activated location-based makeup look for the subject person 108 on a display, such as on a display of the smart cosmetics apparatus 102, a display of the PED 112, a heads-up display, a projected display, etc. In some implementations, the preview/simulation may be, for example, an overlay of a digital image of the subject person 108, where the digital image may be a stored image of the person 108 or may be an image of the person 108 that is being generated in real-time via one or more cameras. In some implementations, the preview may be a virtual reality (VR) simulation or an augmented reality (AR) image of the person 108 in which the activated location-based makeup look has been applied to the person 108 in a virtual or augmented manner. At any rate, responsive to the display of the preview/simulation, one or more modifications to the activated location-specific makeup look may be received from the person 108 or the person's agent and via one or more user interfaces (e.g., of the smart cosmetics apparatus 102 and/or of the PED 112), and the displayed image may be modified or updated in accordance with the received modifications. Modifications, updates, or changes to the previewed/simulated image may be made as often as the person 108 or the agent of the person 108 desires, after which the person 108 or the agent of the person 108 may indicate approval of the resulting previewed/simulated image via the user interface. That is, the person 108 or the agent of the person 108 may approve a suitable preview and/or simulation of the modified location-specific makeup look applied to the person 108. Accordingly, in these embodiments, generating 210 the one or more instructions may include generating one or more instructions for applying or otherwise achieving the approved modifications to the activated location-based makeup look for the person 108, and corresponding control signals may be caused 212 to be transmitted to the smart cosmetics apparatus 102, e.g., in manners similar to those discussed elsewhere herein. If desired, the person 108 or the agent of the person 108 may add the approved and modified location-specific look to the person's profile 125, e.g., as an additional location-specific look or as a substitute for the initially-activated location-specific look. For example, via a user interface at the smart cosmetics apparatus 102 and/or the PED 112, the person 108 or the agent of the person 108 may utilize the location-based makeup look manager 135 to store the modified location-specific look, associate the modified location-specific look with various bounded locations, and the like.

Indeed, in some embodiments (not shown in FIG. 2), the method 200 may include storing data and/or information indicative of an instance of an execution of the method 200. For example, the method 200 may include storing data and/or information indicative of the detection 202 of the subject person 108 entering into the bounded location 105, the determination 205 of the location-specific makeup look for the subject person 108 at the bounded location, the activation 208 of the location-specific makeup look, any modifications thereto, the generation 210 of the instructions for achieving the location-specific makeup look on the person 108 at the bounded location 105, the causing 212 of the one or more control signals to be transmitted to the smart cosmetics apparatus, and/or the application of the activated (and potentially modified) location-based makeup application look to the subject person 108 within the bounded location 105. Such data or information may include, for example, time stamps; user interactions with the system 100, the smart cosmetics apparatus 102, and/or the PED 112; generated instructions; transmitted control signals; whether previews/simulations were generated, modified, or stored; data generated by sensors; changes to the profile 125 of the person 108; initial makeup look worn by the person 108 prior to the execution of the instance of the method 200; duration of the person 108 within the bounded location 105, and/or any other indicative data and/or information. Such data and/or information may be stored (e.g., added to), for example, a historical make-up look data store 162 storing historical data indicative of location-specific makeup looks which have been previously applied to the person 108 and/or to other people, thereby updating the historical data 162 stored therein. The historical make-up look data store 162 may be included in the data store 122, for example. Additionally, in these embodiments, the method 200 may include re-training the ML model 160a based on the updated historical data 162, optionally storing the re-trained ML model (e.g., in the data store 122), and utilizing the re-trained ML model in a subsequent execution of the method 200, e.g., to determine one or more makeup application techniques and/or one or more cosmetics products that are to be utilized in applying or otherwise achieving a subsequently desired, indicated, and/or activated location-specific makeup look on the subject person 108 or on another person. The method 200 may then generate 210 one or more corresponding instructions for applying or otherwise achieving the subsequent location-based makeup look based on an output of the re-trained ML model, and may cause 212 one or more control signals to be transmitted to respective smart cosmetics apparatuses corresponding to associated bounded locations to thereby apply or achieve the subsequently desired, indicated, and/or activated location-specific makeup look on the subject person 108 or on the other person, for example.

This detailed description is to be construed as exemplary only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

Further, upon reading this disclosure, those of skill in the art will appreciate still additional alternative structural and functional designs for a robotic cosmetic application device, and/or systems, methods, and/or techniques associated therewith. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A system, comprising:
a communication interface via which the system is communicatively connected to a smart cosmetics apparatus that is configured to cause makeup looks to be applied to a person;
a data store storing indications of associations between one or more bounded locations and a respective makeup look that is to be applied to the person when the person is within each bounded location of the one or more bounded locations;
one or more processors; and
computer-executable instructions that are stored on one or more memories of the system and that are executable by the one or more processors to cause the system to:
detect, via one or more sensors, that the person has entered into a bounded location in which makeup looks of the person are to be controlled; and
responsive to the detection:
obtain, from the data store, an indication of a location-specific makeup look for the person while the person is within the bounded location, and
transmit, via the communication interface and a wireless transceiver, one or more control signals instructing the smart cosmetics apparatus to cause the location-specific makeup look to be applied to the person.

2. The system of claim 1, wherein the one or more control signals is a first set of control signals, and the computer-executable instructions are further executable by the one or more processors to cause the system to:
detect, via the one or more sensors and subsequent to the transmission of the first set of control signals, that the person has exited from the bounded location; and
transmit, via communication interface and the wireless transceiver, a second set of control signals instructing the smart cosmetics apparatus to cause the location-specific makeup look that has been applied to the person to be modified or removed from the person.

3. The system of claim 1, wherein:
the smart cosmetics apparatus includes a smart cosmetics package in which a cosmetic product is contained;
the transmission of the one or more control signals includes a transmission of a control signal to the smart cosmetics package; and
responsive to a reception of the control signal, the smart cosmetics package dispenses a predetermined amount of the cosmetic product corresponding to the location-specific makeup look for the person.

4. The system of claim 1, wherein:
the smart cosmetics apparatus includes a smart cosmetics applicator;
the transmission of the one or more control signals includes a transmission of a control signal to the smart cosmetics applicator; and
responsive to reception of the control signal, the smart cosmetics applicator applies a cosmetic product to the person in accordance with the location-specific makeup look for the person.

5. The system of claim 1, wherein:
the smart cosmetics apparatus includes a smart cosmetic product;
the transmission of the one or more control signals includes a transmission of a control signal to the smart cosmetic product; and
responsive to reception of the control signal, the smart cosmetic product changes a visual appearance of the smart cosmetic product in accordance with the location-specific makeup look for the person.

6. The system of claim 5, wherein the smart cosmetic product has been applied to the person, and the transmission of the control signal to the smart cosmetic product is a transmission of the control signal to the smart cosmetic product that has been applied to the person.

7. The system of claim 1, wherein:
the smart cosmetics apparatus includes a smart cosmetics guide;
the transmission of the one or more control signals includes a transmission of a control signal to the smart cosmetics guide; and
responsive to a reception of the control signal, the smart cosmetics guide positions an overlay on the person, the overlay being indicative of a guide to applying the location-specific makeup look to the person.

8. The system of claim 7, wherein the overlay is an augmented reality overlay.

9. The system of claim 7, wherein the overlay is customized for the person based on the location-specific makeup look and at least one of: a facial feature of the person, a skin type of the person, a characteristic of an environment of the bounded location, an occasion or event corresponding to the bounded location, or a property of a cosmetic product utilized for the location-specific makeup look.

10. The system of claim 7, wherein the computer-executable instructions are executable to cause the system further to:
present, on a user interface, a simulation of the location-specific makeup look applied to the person within an environment of the bounded location;
receive, via the user interface, of an approval of the simulation; and
responsive to the reception of the approval, generate the overlay in accordance with the approved simulation.

11. The system of claim 10, wherein:
the presentation of the simulation is a presentation of an initial simulation;
the computer-executable instructions are executable to cause the system further to receive, via the user interface, an indication of a change to the initial simulation, and update the simulation in accordance with the change; and
the approval of the simulation is an approval of the updated simulation.

12. The system of claim 10, wherein the simulation is a virtual reality simulation.

13. The system of claim 1, wherein:
the computer-executable instructions are first computer-executable instructions;
the system further comprises second computer-executable instructions stored on the one or more memories and executable by the one or more processors to cause the system further to customize an application of the location-specific makeup look to the person based on at least one of: a facial feature of the person, a skin type of the person, one or more personal preferences of the person, a characteristic of an environment of the bounded location, an occasion or event corresponding to the bounded location, or a property of a cosmetic product utilized for the location-specific makeup look; and
the one or more control signals are indicative of the customization of the application of the location-specific makeup look for the person.

14. The system of claim 13, wherein:
the second computer-executable instructions include a machine learning model trained on historical data indicative of one or more facial features of the person, the skin type of the person, the one or more personal preferences of the person, respective characteristics of a plurality of different environments, one or more respective properties of a plurality of cosmetic products used in creating makeup looks, and a plurality of different makeup looks; and
the system further comprises third computer-executable instructions stored on the one or more memories and executable by the one or more processors to cause the system to:
update the historical data to include data indicative of the application of the location-specific makeup look to the person;
re-train the machine learning model utilizing the updated historical data; and
utilize the re-trained machine learning model to cause a second location-specific makeup look to be applied to the person.

15. The system of claim 1, further comprising a user interface, and wherein at least one of:
the location-specific makeup look is based on one or more preferences indicated by the person or an agent of the person via the user interface; or
the association between the bounded location and the location-specific makeup look for the person is defined via the user interface.

16. The system of claim 15, wherein the definition, via the user interface, of the association between the bounded location and the location-specific makeup look for the person is responsive to a presentation, at the user interface, of a simulation of the location-specific makeup look applied to the person within an environment of the bounded location.

17. The system of claim 1, further comprising the smart cosmetics apparatus.

18. The system of claim 1, wherein the smart cosmetics apparatus is at least one of paired with or authenticated to the system.

19. The system of claim 1, wherein:
the smart cosmetics apparatus is included in a plurality of smart cosmetics apparatuses corresponding to the person;
the plurality of smart cosmetics apparatuses includes two or more of: a smart cosmetics package, a smart cosmetics applicator, a smart cosmetic product, or a smart cosmetics guide; and
the system transmits a respective control signal to each smart cosmetics apparatus, the respective control signal instructing the each smart cosmetics apparatus to cause the location-specific makeup look to be applied to the person.

20. The system of claim 19, wherein the system includes the plurality of smart cosmetics apparatuses corresponding to the person.
